(19) United States
(12) Patent Application Publication
(10) Pub. No.: US 2008/0148263 A1
(43) Pub. Date: Jun. 19, 2008

(54) Method and apparatus for successive data processing by information exchange

(75) Inventors: Weon Il Jin, Suwon-si (KR); Maeng Hee Sung, Suwon-si (KR); Hee Jean Kim, Suwon-si (KR); Tae-Chul Jung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/819,229

(22) Filed: Jun. 26, 2007

(30) Foreign Application Priority Data
Dec. 15, 2006 (KR) 10-2006-0128549

(51) Int. Cl. G06F 9/46

(52) U.S. Cl. 718/101

(57) ABSTRACT

A successive data processing method and apparatus is provided. A data processing apparatus, when connected to a data management apparatus, transmits apparatus information of the data processing apparatus, selects target process data, transmits target process information of the selected target process data, processes the target process data, and transmits process status information according to a process result of the target process data to the data management apparatus.

### CROSS-REFERENCE TO RELATED APPLICATION

This application claims the benefit under 35 U.S.C. § 119(a) of Korean Patent Application No. 10-2006-0128549, filed on Dec. 15, 2006, in the Korean Intellectual Property Office, the entire disclosure of which is hereby incorporated by reference.

### BACKGROUND OF THE INVENTION

1. Field of the Invention

The present invention relates to a successive data processing method and apparatus for performing information exchange between a data management apparatus and a data processing apparatus. More particularly, the present invention relates to a data processing apparatus and a data management apparatus which are capable of seamless service even when the data processing apparatus and the data management apparatus are disconnected and then reset.

2. Description of Related Art

Currently, with the development of various digital devices such as personal computers (PC), personal digital assistants (PDA), digital cameras, moving picture experts group audio-layer 3 (MP3) players, portable multimedia players (PMP), games, digital televisions, and digital versatile disc (DVD) players, the types of data which are processed by such devices have varied from documents to digital contents such videos and music.

Digital data processed by such digital devices has varied and process target data deserves to be protected. Accordingly, the necessity to manage process authorities safely and legally has increased. Moreover, digital rights are violated when protected process target data is spread via networks regardless of the content creator's intention due to the development of network and communication technologies.

Digital rights management (DRM) technologies are developed to protect such digital data. Also, DRM technologies support stability, negotiability, and recyclability with respect to digital data flow and help to satisfy all agents associated with the digital data lifecycle, that is, the copyright holders, distributors, and consumers.

In DRM technologies, apparatuses that store target process data include digital rights management units. Accordingly, process authorities of target process data are confirmed and processed by the apparatuses. However, when data management apparatuses and data processing apparatuses are separated, safe and reliable data processing technologies are required. Also, when target process data, which is processed while connected, is disconnected and reconnected, it is required that the target process data is again processed successively from the previously processed target process data. Also, when data management apparatuses and data processing apparatuses are separated, resistance against removal attacks is required.

When data processing apparatuses include process authorities and management authorities of target process data and restarts data processing, data processing may be available successively from the location that has been processed before. However, when data management apparatuses and data processing apparatuses exist as an independent apparatus, and the data processing apparatuses handles the processing of target process data and the data management apparatus handles process authorities of the target process data, disadvantages may occur. For example, when data management apparatuses and data processing apparatuses are reconnected after having been disconnected, data processing apparatus are required to restart the processing of data, which has previously been processed by the data processing apparatuses. Accordingly, data processing apparatuses are required to successively process data from the next location to the previous location of the data which has been previously processed, which is called a successive data processing problem. When data management apparatuses and data processing apparatuses process data are suddenly disconnected, the data processing apparatuses are required to determine whether data processing operation is continued.

Accordingly, there is a need for an improved successive data processing method and apparatus, which may have resistance against removal attack by receiving and processing process authority information in the data management apparatus based on the process authority information every time the data processing operation continued.

### SUMMARY OF THE INVENTION

Exemplary embodiments of the present invention address at least the above problems and/or disadvantages and provide at least the advantages described below. Accordingly, an aspect of exemplary embodiments of the present invention is to provide a successive data processing method and apparatus for performing information exchange wherein the data management apparatus authorizes the data processing apparatus and provides process authority information, which may process target process data of the authorized data processing apparatus when connected to each other, to thereby process data safely and reliably.

Exemplary embodiments of the present invention also provide a successive data processing method and apparatus for performing information exchange wherein the data management apparatus and the data processing apparatus share process status information of the data processing apparatus, when connected to each other, and thereby successively process data based on process location information of the data which has been processed when disconnected and reconnected.

Exemplary embodiments of the present invention also provide a successive data processing method and apparatus for performing information exchange, which have a resistance against a removal attack by exchanging process status information and process authority information when the data management apparatus and the data processing apparatus are connected, wherein the data processing apparatus examines the process authority information of target process data when disconnected, and does not perform a process operation of the target process data when the process authority information is not received.

According to an aspect of exemplary embodiments of the present invention, there is provided a successive data processing method for performing information exchange between a data management apparatus and a data processing apparatus, the method including selecting target process data; transmitting target process information of the selected target process data to the data management apparatus; receiving process authority information based on the target process information from the data management apparatus; processing the target process data based on the process authority information; and transmitting process status information according to a status of the target process data to the data management apparatus.

Exemplary embodiments of the present invention also provide that a data processing apparatus transmit data processing apparatus information to the data management apparatus when connected to the data management apparatus, and receives selection information which is authorized by the data management apparatus based on an identification (ID) of the data processing apparatus included in the data processing apparatus information, which includes target process information or process status information.

Exemplary embodiments of the present invention also provide that a process information, transmitted from the data management apparatus to the data processing apparatus, includes the target process information, process status information, or process authority information, wherein the target process information includes an ID of the target process data, and the process status information includes process completion information or process location information according to a process status of the target process data.

Exemplary embodiments of the present invention also provide that a process completion information indicates a process incompletion when the target process data to be processed remains, and a process completion when a processing of the target process data is completed according to a process result of the target process data, and is a standard for determining the process completion and a process maintenance based on the process completion information. Also, in the case of the process completion, the process completion information is transmitted to the data management apparatus, and when the target process data to be processed remains, the process status information up to a current point in time is transmitted to the data management apparatus.

Exemplary embodiments of the present invention also provide that a process location information is to determine a subsequent process location and restart processing by informing a process status, up to a current point in time of the target process data, when the data processing apparatus processes the target process data. The process location information is transmitted to the data management apparatus and stored.

Exemplary embodiments of the present invention also provide that the process authority information is transmitted from the data management apparatus to the data processing apparatus, and includes an authority to process the target process data.

Exemplary embodiments of the present invention also provide that the data processing apparatus may transmit a target process information inquiry message, inquiring whether data to be processed exists, when connected to the data management apparatus. The data management apparatus generates the selection information corresponding to the ID of the data processing apparatus in response to the target process information inquiry message, and the data processing apparatus receives the selection information. The selection information includes the target process information or the target status information. The target process information or the target status information informs that target process data, which is not completely processed, exist while the data management apparatus is connected to the data processing apparatus.

Exemplary embodiments of the present invention also provide that the data processing apparatus may select the target process data based on the selection information received from the data management apparatus or a user input signal when connected to the data management apparatus.

According to another aspect of exemplary embodiments of the present invention, there is provided a successive data processing method performed by information exchange between a data management apparatus and a data processing apparatus, the method including receiving target process information of target process data from the data processing apparatus; generating process authority information of the target process data based on the target process information and transmitting the generated process authority information to the data management apparatus; and receiving process status information according to a status of the target process data, which is processed based on the process authority information, from the data processing apparatus.

Exemplary embodiments of the present invention also provide that the process status information includes process completion information and/or process location information, and an operation for generating process information required to process data in the data processing apparatus based on the process completion information, and transmitting the process information to the data processing apparatus is repeated until processing of the target process data is completed.

According to still another aspect of exemplary embodiments of the present invention, there is provided data processing apparatus, including an interface unit for connecting to an external device and interfacing with any one of target process data, information, and a message; a data processing unit for receiving data from the interface unit and processing the target process data based on process instruction information; and a control unit for interpreting the message received via the interface unit, generating a message in response to a result of the interpretation, transmitting the message in response to the result of the interpretation via the interface unit, generating the process instruction information for the processing of the target process data, outputting the process instruction information to the data processing unit, and transmitting process status information according to a result of the data processed in the data processing unit, which is based on the process instruction information, to the data management apparatus via the interface unit.

Exemplary embodiments of the present invention also provide that the data processing apparatus may further include a display unit for displaying the process status information and information of the target process data according to a processing operation of the data processing unit with respect to the target process data.

Exemplary embodiments of the present invention also provide that the data processing apparatus may further include a storage unit for receiving any one of the target process data, the information, and the message from the interface unit, and storing the received target process data, the information, and the message.

Exemplary embodiments of the present invention also provide that the external device may be a display device connected via the interface unit and display processed data, information, or a message which is generated by a data processing.

Exemplary embodiments of the present invention also provide that the external device connected via the interface unit may be the data management apparatus which manages target process data of the data processing apparatus.

Exemplary embodiments of the present invention also provide that when the data processing apparatus is connected to the data management apparatus, the control unit transmits a data processing apparatus ID to the data management apparatus via the interface unit, and the data processing apparatus is authorized by the data management apparatus.

Exemplary embodiments of the present invention provide that a control unit of the data processing apparatus generates a target process information inquiry message, which inquires whether the target process data exists in the data management apparatus, transmits the target process information inquiry message to the data management apparatus via the interface unit, interprets selection information received from the data management apparatus via the interface unit, and selects the target process data based on the interpreted selection information or a user input signal.

Exemplary embodiments of the present invention provide that a control unit generates the process instruction information when the control unit interprets process authority information of the target process data, which is received from the data management apparatus, and when a process authority is provided. The process instruction information is transmitted to the data processing unit, and the target process data is processed according to the process instruction information.

According to yet another aspect of exemplary embodiments of the present invention, a data management apparatus, including an interface unit for connecting to an external device and interfacing with any one of target process data, information, and a message; a storage unit for storing the target process data; and a control unit for interpreting the target process data, the information, and the message received via the interface unit, generating storage instruction information, outputting the storage instruction information to the storage unit, generating process authority information of the target process data, based on the target process data, and transmitting the process authority information to the external device via the interface unit.

Exemplary embodiments of the present invention provide that a data management apparatus may further include a digital rights management unit for either authorizing the external device or issuing the process authority information of the target process data.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following detailed description, taken in conjunction with the accompanying drawings in which:

FIG. 1 is a diagram illustrating a configuration of a data processing apparatus according to an exemplary embodiment of the present invention;

FIG. 2 is a diagram illustrating a configuration of a data processing apparatus according to another exemplary embodiment of the present invention;

FIG. 3 is a diagram illustrating a configuration of a data processing apparatus according to still another exemplary embodiment of the present invention;

FIG. 4 is a diagram illustrating a configuration of a data processing apparatus according to yet another exemplary embodiment of the present invention;

FIG. 5 is a diagram illustrating a configuration of a data management apparatus according to a further exemplary embodiment of the present invention;

FIG. 6 is a diagram illustrating a configuration of a data management apparatus according to another exemplary embodiment of the present invention;

FIG. 7 is a flowchart illustrating an operation of a data processing apparatus according to an exemplary embodiment of the present invention;

FIG. 8 is a flowchart illustrating an operation of a data processing apparatus according to another exemplary embodiment of the present invention;

FIG. 9 is a flowchart illustrating an operation of a data management apparatus according to an exemplary embodiment of the present invention; and

FIG. 10 is a flowchart illustrating an operation of a data management apparatus according to another exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

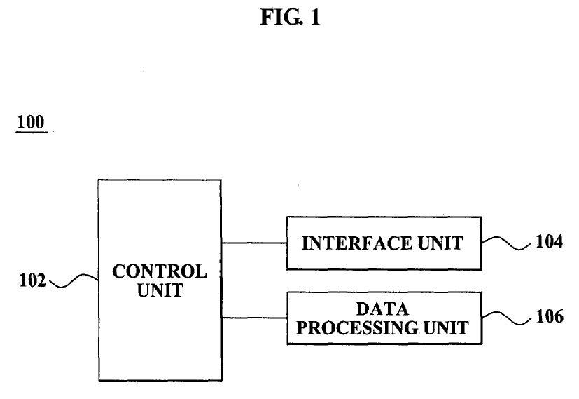

FIG. 1 is a diagram illustrating a configuration of a data processing apparatus according to an exemplary embodiment of the present invention. Referring to FIG. 1, a data processing apparatus 100 includes a control unit 102, an interface unit 104, and a data processing unit 106.

The interface unit 104 is connected to an external device, and interfaces with any one of target process data, information, and a message.

The data processing unit 106 receives the target process data from the interface unit 104, and processes the target process data based on process instruction information.

The control unit 102 interprets a message received via the interface unit 104, generates a message in response to a result of the interpretation, and transmits the message in response to the result of the interpretation via the interface unit 104. Also, the control unit 102 generates process instruction information for processing of the target process data by interpreting process information which is received from the external device via the interface unit, outputs the process instruction information to the data processing unit 106, and transmits process status information according to a result of processing data, processed in the data processing unit 106 based on the process instruction information, to the external device via the interface unit 104.

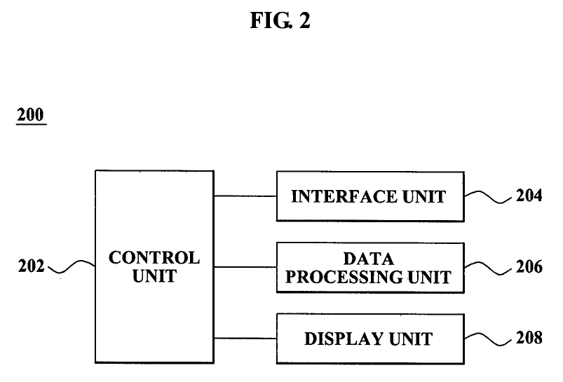

FIG. 2 is a diagram illustrating a configuration of a data processing apparatus according to another exemplary embodiment of the present invention. Referring to FIG. 2, a data processing apparatus 200 includes a control unit 202, an interface unit 204, a data processing unit 206, and a display unit 208.

The interface unit 204 performs substantially the same operation as the interface unit 104 of FIG. 1.

The data processing unit 206 performs substantially the same operation as the data processing unit 106 of FIG. 1.

The display unit 208 displays a target process data identifier, process completion information, or process location information. The target process data identifier is included in target process information processed in the data processing unit 206. The process completion information is generated according to a process status of the target process data, and indicates whether a processing of target process data is completed. The process location information indicates which portion of the target process data is being processed.

The control unit 202 interprets a message received via the interface unit 204, generates a message in response to a result of the interpretation, and transmits, via the interface unit 204, the message in response to the result of the interpretation. Also, the control unit 202 generates process instruction information for processing of the target process data, outputs the process instruction information to the data processing unit 206, and transmits process status information to an external device via the interface unit 204. In this instance, the process status information depends on a result of processing data, processed in the data processing unit, based on the process instruction information. Also, the control unit 202 generates and displays display instruction information instructing the target process information or the process status information to be displayed in the display unit 208.

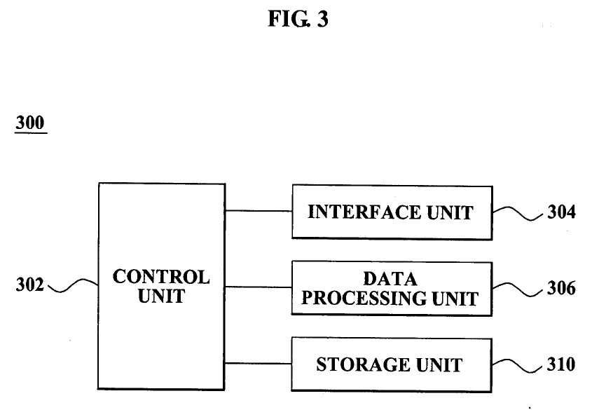

FIG. 3 is a diagram illustrating a configuration of a data processing apparatus according to another exemplary embodiment of the present invention. Referring to FIG. 3, a data processing apparatus 300 includes a control unit 302, an interface unit 304, a data processing unit 306, and a storage unit 310.

The interface unit 304 performs substantially the same operation as the interface unit 104 of FIG. 1.

The data processing unit 306 performs substantially the same operation as the data processing unit 106 of FIG. 1.

The storage unit 310 stores target process data received from either an external unit via the interface unit 304, or target process data, previously stored in a compact disc (CD), a digital versatile disc (DVD), or a form of memory.

The control unit 302 interprets a message received via the interface unit 304, generates a message in response to a result of the interpretation, and transmits the message in response to the result of the interpretation via the interface unit 304. Also, the control unit 302 generates process instruction information for processing of the target process data, outputs the process instruction information to the data processing unit 306, and transmits process status information to an external device via the interface unit 304. In this instance, the process status information depends on a result of processing data, processed in the data processing unit 306, based on the process instruction information. Also, the control unit 302 extracts the target process data from the storage unit 320 and instructs the target process data to be processed in the data processing unit 306.

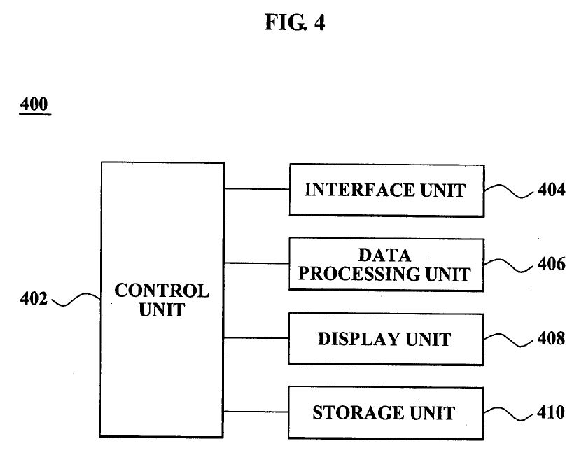

FIG. 4 is a diagram illustrating a configuration of a data processing apparatus according to another exemplary embodiment of the present invention. Referring to FIG. 4, a data processing apparatus 400 includes a control unit 402, an interface unit 404, a data processing unit 406, a display unit 408, and a storage unit 410.

The interface unit 404 performs substantially the same operation as the interface unit 104 of FIG. 1.

The data processing unit 406 performs substantially the same operation as the data processing unit 106 of FIG. 1.

The display unit 408 performs substantially the same operation as the display unit 208 of FIG. 2.

The storage unit 410 performs substantially the same operation as the storage unit 310 of FIG. 3.

The control unit 402 interprets a message received via the interface unit 404, generates a message in response to a result of the interpretation, and transmits the message in response to the result of the interpretation via the interface unit 404. Also, the control unit 402 generates process instruction information for processing of the target process data, outputs the process instruction information to the data processing unit 406, and transmits process status information to an external device via the interface unit 404. In this instance, the process status information depends on a result of processing data, processed in the data processing unit 406, based on the process instruction information. Also, the control unit 402 generates and displays display instruction information instructing the target process information or the process status information to be displayed in the display unit 408, extracts the target process data from the storage unit 410 and instructs the target process data to be processed in the data processing unit 406.

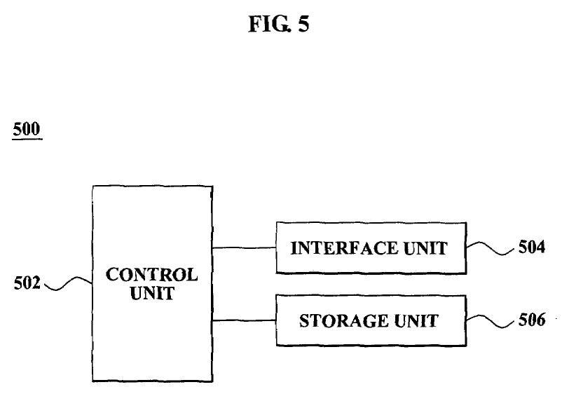

FIG. 5 is a diagram illustrating a configuration of a data management apparatus according to a further exemplary embodiment of the present invention. Referring to FIG. 5, a data management apparatus 500 includes a control unit 502, an interface unit 504, and a storage unit 506.

The interface unit 504 is connected to an external device, and interfaces with any one of target process data, information, and a message.

The storage unit 506 receives the target process data from the external device via the interface unit 504, and stores external device information, the message, and relevant data.

The control unit 502 interprets any one of the target process data, the information, and the message, received via the interface unit 504, generates storage instruction information in response to a result of the interpretation, and outputs the storage instruction information to the storage unit 506. Also, the control unit 502 generates process information of the target process data, based on the target process data, and transmits the process information to the external device via the interface unit 504.

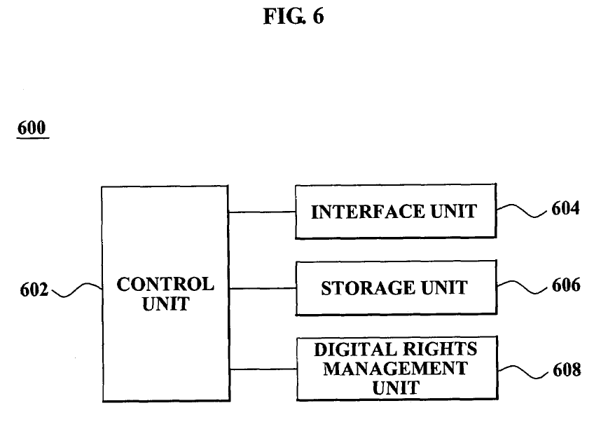

FIG. 6 is a diagram illustrating a configuration of a data management apparatus according to another exemplary embodiment of the present invention. Referring to FIG. 6, a data management apparatus 600 includes a control unit 602, an interface unit 604, a storage unit 606, and a digital rights management unit 608.

The interface unit 604 performs substantially the same operation as the interface unit 504 of FIG. 5.

The storage unit 606 performs substantially the same operation as the storage unit 506 of FIG. 5.

The digital rights management unit 608 performs an authorization of an external device based on an identification (ID) of the external device connected via the interface unit 604, or issues process authority information based on an ID of target process data selected by the external device.

The control unit 602 interprets any one of the target process data, information, and a message, received via the interface unit 604, generates either storage instruction information or the message in response to a result of the interpretation, and outputs the storage instruction information to store the storage instruction information in the storage unit 606. Also, the control unit 602 transmits process information to the external device via the interface unit 604. In this instance, the process information includes the process authority information issued in the digital rights management unit 608.

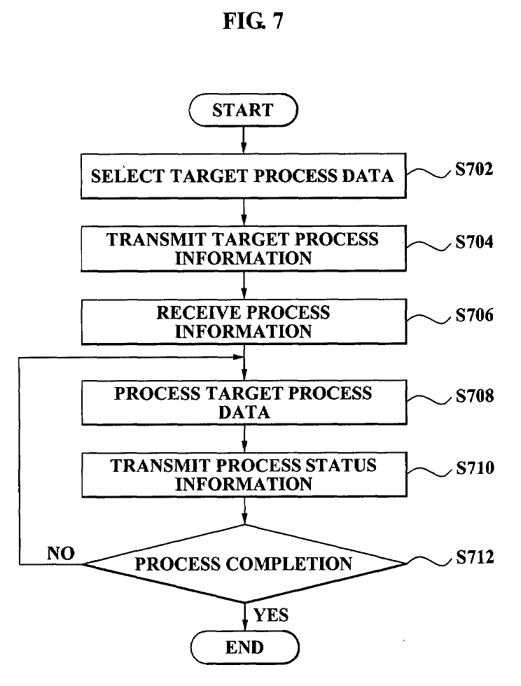

FIG. 7 is a flowchart illustrating an operation of a data processing apparatus according to an exemplary embodiment of the present invention. Referring to FIG. 7, the data processing apparatus is connected to an external device via an interface unit, and the external device corresponds to a data management apparatus which manages target process data. The data processing apparatus, connected to the data management apparatus, selects the target process data in operation S702. Target process information corresponding to the selected target process data is transmitted to the data management apparatus in operation S704. Referring to Table 1, the target process information includes information such as an ID, an identifier, a size, and a type of the target process data.

TABLE 1
Process information

| Target process | | | | | Process authority | |
|---|---|---|---|---|---|---|
| information | | Process status information | | | information | |
| Target process | . . . | Process | Process | . . . | Process | . . . |
| data ID | | completion | location | | right | |
| | | information | information | | information | |

Process information of the target process data is received in operation S706. In this instance, the process information of the target process data is transmitted from the data management apparatus based on the target process information. A data processing unit of the data processing apparatus processes the target process data based on the process information in operation S708. Process status information is generated according to a process result of the target process data. Referring to Table 1, the process status information includes process completion information and process location information. The process completion information indicates whether the process is completed, and the process location information indicates how much of the target process data has been processed. When sharing the process location information in the data management apparatus and the data processing apparatus, and processing of the target process data, the process location information determines a location for processing of the target process data.

The generated process status information is transmitted to the data management apparatus in operation S710, a completion of the processing of the target process data is confirmed in operation S712, and the processing of the target process data is completed.

When the processing of the target process data is not completed, the process completion information includes an incompletion property. When the processing of the target process data is completed, the process completion information includes a process completion property. When the processing of the target process data is not completed, the process status information is transmitted to the data management apparatus. The process status information includes the process location information which indicates a location where the target process data is currently processed, or a location where the target process data will be processed. The processing of the target process data in operation S708, the transmitting of the process status information in operation S710, and the confirmation of whether the processing of the target process data is completed in operation S712 are repeated until the processing of the target process data is completed. The data processing apparatus described above may complete processing of the target process data based on received process right information, even when disconnected from the data management apparatus. Accordingly, in order to stop processing of the target process data when disconnected, the process information, received from the data management apparatus, is verified before performing the processing of the target process data in operation S708. When the process right information is received, the processing of the target process data may be performed. Otherwise, the processing of the target process data may be stopped.

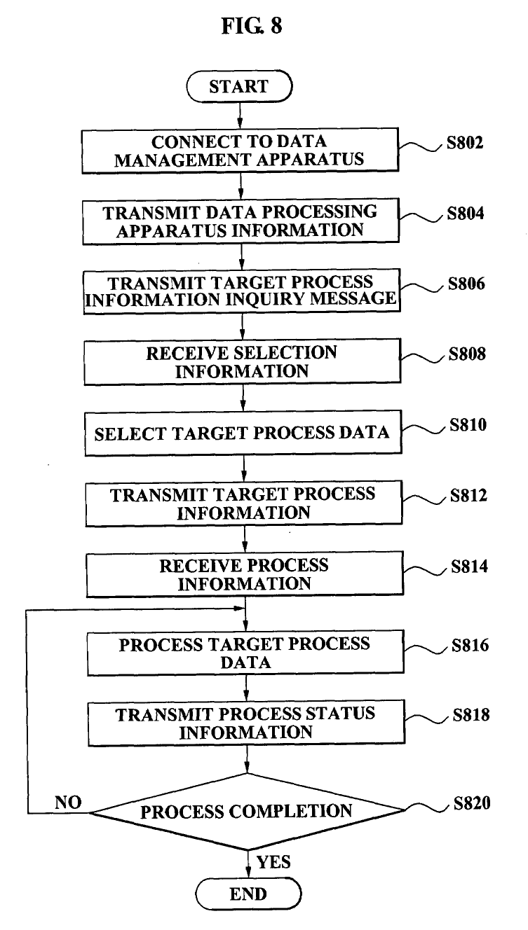

FIG. 8 is a flowchart illustrating an operation of a data processing apparatus according to an exemplary embodiment of the present invention. Referring to FIG. 8, the data processing apparatus is connected to a data management apparatus via an interface unit in operation S802. The data processing apparatus transmits data processing apparatus information, that is, apparatus information of the data processing apparatus, to the data management apparatus in operation S804. Referring to Table 2, the data processing apparatus information includes information such as a data processing apparatus ID, a data processing apparatus manufacturer, or a data processing apparatus type.

TABLE 2
Data processing apparatus information

| | | | |
|---|---|---|---|
| Data processing | Data processing | Data processing | . . . |
| apparatus ID | apparatus manufacturer | apparatus type | |

The data processing apparatus receives selection information, transmitted from the data management apparatus, in operation S808. Referring to Table 3, the selection information includes target process information or process status information.

TABLE 3
Selection information

| | |
|---|---|
| Target process information | Process status information |

The data processing apparatus may receive the selection information, since the data management apparatus generates the selection information based on authorized data processing apparatus information and transmits the selection information. However, the data processing apparatus transmits the data processing apparatus information in operation S804, and may transmit a target process information inquiry message to the data management apparatus in operation S806. The target process information inquiry message inquires whether uncompleted target process data exists when connected to the data management apparatus.

The data processing apparatus may select the target process data from data where the processing has not been completed, based on either the selection information or a user input signal. When the target process data is selected in operation S810, target process information is transmitted to the data management apparatus by generating the target process information in operation S812.

The data processing apparatus receives process information, including process authority information, from the data management apparatus in operation S814. The process authority information includes a process authority of the target process data. The target process data is processed based on the process instruction information in operation S816. In this instance, the process instruction information is based on process authority information, and is instructed from a control unit to a data processing unit. Also, process status information is generated according to a process status of the target process data. The process status information is transmitted to the data management apparatus in operation S818. Whether the processing of the target process data is completed is confirmed in operation S820.

The processing of the target process data is completed based on process completion information included in the process status information.

When the processing of the target process data is not completed, the process completion information includes property information indicating a process incompletion status, and the process status information is transmitted to the data management apparatus. In this instance, the process status information includes the process location information. The process location information indicates a location where the target process data is currently processed, or a location where the target process data will be processed. The processing of the target process data in operation S816, the transmitting of the process status information in operation S818, and the confirmation of whether the processing of the target process data is completed in operation S820 are repeated until the processing of the target process data is completed. The data processing apparatus described above may complete processing of the target process data based on received process right information, even when disconnected from the data management apparatus. Accordingly, in order to stop processing the target process data when disconnected, the process information received from the data management apparatus is examined before performing the processing of the target process data in operation S816. When the process right information is received in operation S814, the processing of the target process data may be performed. Otherwise, the processing of the target process data may end.

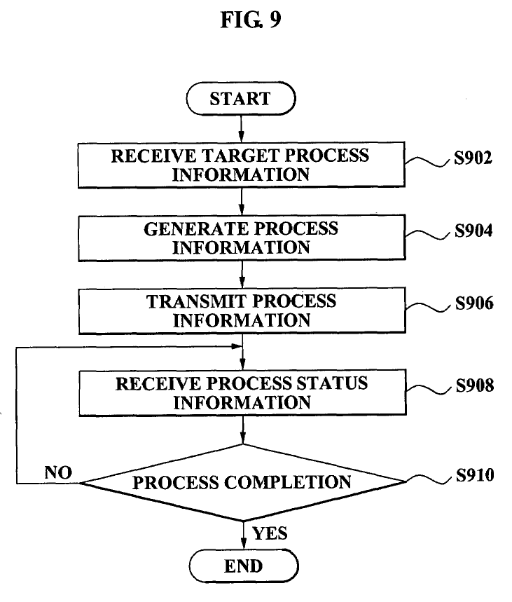

FIG. 9 is a flowchart illustrating an operation of a data management apparatus according to an exemplary embodiment of the present invention. Referring to FIG. 9, the data management apparatus is connected to an external device via an interface unit. The external device corresponds to a data processing apparatus which processes target process data. The data management apparatus, connected to the data processing apparatus, receives target process information indicating the target process data in operation S902. Process information as illustrated in Table 1 is generated based on a target process data ID of the target process information in operation S904. The process information is transmitted to the data processing apparatus in operation S906. Process status information generated by the data processing apparatus is received in operation S908, and stored in a storage unit. Accordingly, process location information is shared in the data processing apparatus and the data management apparatus according to a process status of the target process data. Whether a processing of the target process data is completed may be confirmed based on process completion information included in the process status information in operation S910. Accordingly, the receiving the process status information in operation S908 and the confirming whether the processing of the target process data is completed in operation S910 are repeated based on the process completion information.

The data management apparatus as described above may continue to process the target process data based on transmitted process authority information, even when disconnected from the data processing apparatus. Accordingly, in order to stop processing the target process data when disconnected, the transmitting of the process information to the data processing apparatus in operation S906 is repeated before receiving the process status information in operation S908. Thus, the data processing apparatus may perform the processing of the target process data based on the process information, and may end the processing when the process information is not received.

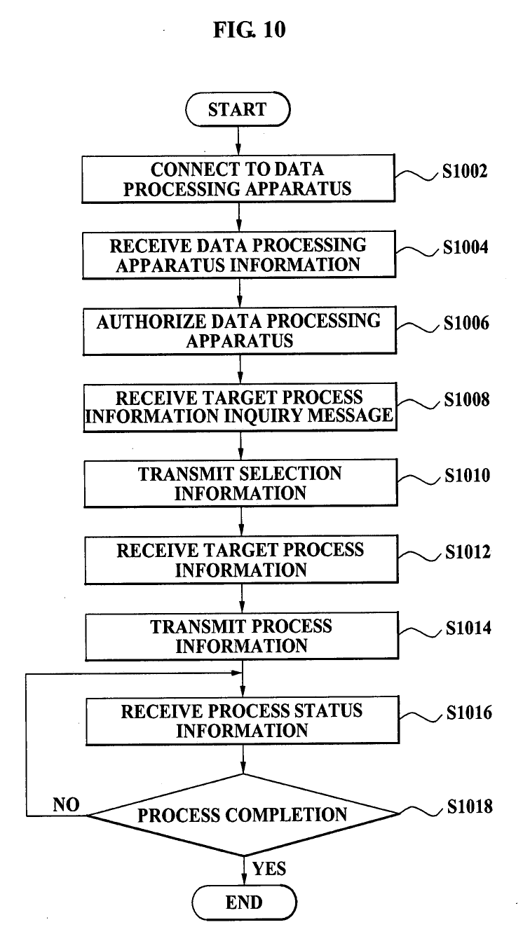

FIG. 10 is a flowchart illustrating an operation of a data management apparatus according to an exemplary embodiment of the present invention. Referring to FIG. 10, the data management apparatus is connected to a data processing apparatus via an interface unit in operation S1002. The data management apparatus receives data processing apparatus information from the data processing apparatus in operation S1004, and authorizes the data processing apparatus based on data processing apparatus ID included in the data processing apparatus information in operation S1006.

The data management apparatus may search for target process data, which has not been processed before when disconnected, based on the data processing apparatus ID, make a list of the target process data, and generate selection information to determine whether the data processing apparatus may restart processing of the target process data. Accordingly, the selection information is transmitted in operation S1010. The selection information includes target process information or process status information as illustrated in Table 3. Prior to transmitting the selection information in operation S1010, the data management apparatus may receive target process information inquiry message from the data processing apparatus in operation S1008. The target process information inquiry message inquires whether uncompleted target process data exists. Also, the target process information inquiry message is interpreted in a control unit of the data management apparatus. The selection message corresponding to a target process data ID is generated and transmitted to the data processing apparatus.

When the data management apparatus receives target process information of the selected target process data from the data processing apparatus in operation S1012, the control unit of the data management apparatus generates process authority information including a process authority of the target process data. Otherwise, when receiving the target process information of the selected target process data in operation S1012, a data management apparatus including a digital rights management unit transmit process information to the data processing apparatus via the interface unit according to a control of the control unit in operation S1014. The process information includes process authority information issued by the digital rights management unit.

The data management apparatus receives the process status information generated according to a process status of the target process data which is processed in the data processing apparatus in operation S1016.

When the process status information is received in operation S1016, the process status information is stored in a storage unit. Whether the processing of the target process data is completed based on process completion information, which is included in the process status information, is confirmed in operation S1018.

As described above, the data processing apparatus and the data management apparatus share process location information included in the process status information, which is received from the data processing apparatus.

The data management apparatus repeats the receiving the process status information in operation S1016 and the confirming in operation S1018 until the processing of the target process data is completed based on the received process completion information.

The data management apparatus as described above may continue to process the target process data based on transmitted process authority information, even when disconnected from the data processing apparatus. Accordingly, in order to stop processing the target process data when disconnected, the transmitting of the process information to the data processing apparatus in operation S1014 is repeated before receiving the process status information in operation S908. Thus, the data processing apparatus may perform the processing of the target process data based on the process information, and may end the process when the process information is not received.

According to another aspect of exemplary embodiments of the present invention, a data management apparatus includes a storage unit for storing an ID of target process data of a data processing apparatus, which is physically separated from the data management apparatus, and process location information of the target process data. Also, the data management apparatus includes a control unit for transmitting the ID of the target process data of the data processing apparatus and the process location information of the target process data to the data processing apparatus when reconnected to the data processing apparatus.

The data processing apparatus transmits an ID of the data processing apparatus and the ID of the target process data, which is being processed or will be processed, to the data management apparatus. Then, the data management apparatus stores the ID of the target process data by corresponding to an ID of the data processing apparatus. The data management apparatus authorizes the data processing apparatus and transmits target process data corresponding to the ID of the target process data in predetermined amounts. The data processing apparatus processes the target process data received from the data management apparatus. The data processing apparatus transmits process location information of the target process data to the data management apparatus every time processing of the target process data, by the predetermined unit of the target process data, is performed. For example, when the target process data may be video data, the data processing apparatus may transmit process location information of the target process data to the data management apparatus by increasing the process location information by 1 every time 10 MB of the video data is played. Accordingly, the data management apparatus stores the process location information in the storage unit by corresponding to the ID of the data processing apparatus.

According to still another aspect of exemplary embodiments of the present invention, the target process data may not be transmitted to the data processing apparatus from the data management apparatus, and may be initially stored in the data processing apparatus. In this case, the data management apparatus transmits an authority of a portion of the target process data, and may enable the data processing apparatus to process the target process data by a predetermined unit of the target process data. For example, when receiving an authority of video data of a beginning portion, 50 MB out of 400 MB, from the data management apparatus, the data processing apparatus may play the 50 MB of the video data. In this instance, the video data is the target process data. Every time 10 MB of the video data is played, the data processing apparatus may transmit process location information by increasing the process location information by 1. Accordingly, the data management apparatus stores the process location information in the storage unit by corresponding to the ID of the data processing apparatus.

When disconnected and then reconnected to the data processing apparatus, the data management apparatus identifies the ID of the data processing apparatus. Then, the data management apparatus identifies the ID of the target process data and the process location information of the target process data by referring to the ID of the data processing apparatus. The identified ID of the target process data and the process location information of the target process data are transmitted to the data processing apparatus. Accordingly, the data processing apparatus determines which data is being processed by the data processing apparatus through the received ID of the target process data and consecutively processes the target process data by referring to the process location information of the target process data. For example, when the target process data is video, the data processing apparatus may play the target process data from a location where the processing of the target process data has been stopped.

According to an aspect of exemplary embodiments of the present invention, a successive data processing method and apparatus for performing information exchange wherein the data management apparatus authorizes the data processing apparatus, and provides a process authority of target process data, when connected to each other, to thereby process data safely and reliably.

Also, according to an aspect of exemplary embodiments of the present invention, a successive data processing method and apparatus for performing an information exchange wherein the data management apparatus and the data processing apparatus share process status information according to a data processing result of the data processing apparatus when connected to each other, and processing data to thereby successively process data based on process location information of target process data, which has been previously processed when disconnected and reconnected.

Also, according to an aspect of exemplary embodiments of the present invention, a successive data processing method and apparatus for performing information exchange, which have a resistance against a removable attack, by sharing process status information and process authority information of target process data when the data management apparatus and the data processing apparatus are connected, and by examining the process authority information of target process data by the data processing apparatus when disconnected.

While the invention has shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A successive data processing method performed by information exchange between a data management apparatus and a data processing apparatus, the method comprising the steps of:
selecting target process data;
transmitting target process information of the selected target process data to the data management apparatus;
receiving process authority information based on the target process information from the data management apparatus;
processing the target process data, which is based on the process authority information; and
transmitting process status information according to a status of the target process data to the data management apparatus.

2. The method of claim 1, wherein the data processing apparatus transmits data processing apparatus information to the data management apparatus when connected to the data management apparatus, and receives authorized selection information according to the data processing apparatus information.

3. The method of claim 2, wherein the data processing apparatus information includes an identification (ID) of the data processing apparatus.

4. The method of claim 1, wherein the target process information includes an ID of the target process data.

5. The method of claim 1, wherein the process status information includes any one of process completion information and process location information of the target process data.

6. The method of claim 5, wherein a process location of the target process data is determined based on the process location information.

7. The method of claim 5, wherein the process completion information is a standard for determining any one of a data processing and a transmission of the process status information.

8. The method of claim 1, further comprising the steps of:
transmitting a target process information inquiry message to the data management apparatus; and
receiving selection information of the target process data in response to the target process information inquiry message.

9. The method as in any one of claims 2 and 8, wherein the target process data is selected based on the selection information received from the data management apparatus.

10. The method of claim 1, wherein the target process data is selected based on a user input signal.

11. The method of claim 1, wherein when a processing of the target process data is not completed, the processing of the target process data and the transmitting process status information is repeated until the processing of the target data is completed.

12. A successive data processing method performed by information exchange between a data management apparatus and a data processing apparatus, the method comprising the steps of:
receiving target process information of target process data from the data processing apparatus;
generating process authority information of the target process data based on the target process information, and transmitting the generated process authority information to the data management apparatus; and
receiving process status information according to a status of the target process data, which is based on the process authority information, from the data processing apparatus.

13. The method of claim 12, wherein the process status information includes process completion information or process location information, and wherein an operation for generating process information required to process data in the data processing apparatus based on the process completion information, and transmitting the process information to the data processing apparatus is repeated until a processing of the target process data is completed.

14. A data processing apparatus, comprising:
an interface unit for connecting to an external device and interfacing with any one of target process data, information, and a message;
a data processing unit for receiving data from the interface unit and processing the target process data, which is based on process instruction information; and
a control unit for interpreting the message received via the interface unit, generating a message in response to a result of the interpretation, transmitting the message in response to the result of the interpretation via the interface unit, generating the process instruction information for the processing of the target process data, outputting the process instruction information to the data processing unit, and transmitting process status information according to a result of the processing of the data, which is processed in the data processing unit, based on the process instruction information, to the external device via the interface unit.

15. The data processing apparatus of claim 14, further comprising:
a display unit for displaying the process status information and information of the target process data according to a processing operation with respect to the target process data by the data processing unit.

16. The data processing apparatus as in any one of claims 14 and 15, further comprising:
a storage unit for receiving any one of the target process data, the information, and the message from the interface unit, and storing the received target process data, the information, and the message.

17. The data processing apparatus of claim 14, wherein the external device is a display device.

18. The data processing apparatus of claim 14, wherein the external device corresponds to a data management apparatus.

19. The data processing apparatus of claim 18, wherein the control unit transmits a data processing apparatus ID to the data management apparatus via the interface unit.

20. The data processing apparatus of claim 19, wherein the control unit generates a target process information inquiry message, transmits the target process information inquiry message to the data management apparatus via the interface unit, interprets selection information received from the data management apparatus via the interface unit, and selects the target process data based on the selection information.

21. The data processing apparatus of claim 14, wherein the control unit selects the target process data based on a user input signal.

22. A data management apparatus, comprising:
an interface unit for connecting to an external device and interfacing with any one of target process data, information, and a message;
a storage unit for storing the target process data; and
a control unit for interpreting the target process data, the information, and the message received via the interface unit, generating storage instruction information, storing the target process data in the storage unit according to the storage instruction information, generating process authority information of the target process data, which is based on the target process data, and transmitting the process authority information to the external device via the interface unit.

23. The data management apparatus of claim 22, further comprising:
a digital rights management unit for either authorizing the external device or issuing the process authority information of the target process data.

24. A data management apparatus, comprising:
a storage unit for storing an ID of target process data of a data processing apparatus, which is physically separated from the data management apparatus, and processing location information of the target process data; and
a control unit for transmitting the ID of the target process data of the data processing apparatus and the process location information of the target process data to the data processing apparatus when reconnected to the data processing apparatus.

25. The data management apparatus of claim 24, wherein the storage unit stores the ID of the target process data of the data processing apparatus and the process location information of the target process data by corresponding to an ID of the data processing apparatus.

26. The data management apparatus of claim 25, wherein the control unit identifies the ID of the target process data of the data processing apparatus and the process location information of the target process data by referring to the ID of the data processing apparatus when reconnected to the data processing apparatus.
